(19) United States
(12) Patent Application Publication
(10) Pub. No.: US 2002/0105944 A1
(43) Pub. Date: Aug. 8, 2002

(54) Method for control of telephony devices

(76) Inventor: Christian Stredicke, Berlin (DE)

Correspondence Address: Peter G. Pappas, SUTHERLAND ASBILL & BRENNAN LLP, 999 Peachtree Street, NE, Atlanta, GA, 30309-3996, US

(21) Appl. No.: 10/060,094

(22) Filed: Jan. 29, 2002

(30) Foreign Application Priority Data
Feb. 1, 2001 (DE) 10104581.6

(51) Int. Cl. H04L 12/66

(52) U.S. Cl. 370/352; 370/522

(57) ABSTRACT

The invention relates to a method for the control of telephony devices and a telephony apparatus, which has at least one connection for the exchange of packet oriented exchange of audio data and at least one additional port for the exchange of signaling information with a network element (3) as well as a server connection, where the telephone device (2) can be connected via the server connection with the server device (1) in a way that between the telephone device (2) and the server device (1) electronic data can be exchanged, the method comprising the following steps: transmission of signaling information from a network element (3) to a telephone device (2) via a signaling port; at least partial forwarding of the received signaling information from the telephone device (2) to the server device (1) via the server connection; processing of the at least partial forwarded information in the server device (1), so that signaling information for the telephone device (2) are generated; transmission of the generated signaling information from the server device (1) to the telephone device (2) via the server connection; and processing of the transmitted signaling information in the telephone device (2) so that the control of the telephone device (2) is automatically achieved in the context of packet oriented exchange of audio data via at least one audio data connection by the transmitted.

The invention is about a method for the control of telephony devices and a telephony apparatus.

More and more telephone calls are transmitted over packet oriented networks. The underlying technology is called “VoIP”—technology (VOIP meaning “Voice over Internet Protocol”). In this technology, analog audio signals are digitized before they are transmitted over a digital network as a stream of data packets. Such networks allow data packets to find their way independently in principle, so that network capacities can be used efficiently according to their availability over time. Data packets originating from a single source may therefore take different paths to their destination, and therefore the time of arrival may jitter. At the destination, the packets are sorted according to the time they were sampled and put together as a continuous stream of speech or audio signals. VoIP technology ensures that the reconstruction of the audio signals works smooth and has the advantage that both audio signals as well as other electronic data can be transmitted. This allows the usage of a network infrastructure for the transmission of different electronic information types including VoIP audio packets.

A telephone device that is used in this environment must be on the one hand able to exchange the speech or audio information. On the other hand, it has to exchange and process electronic signaling information. Signaling information is exchanged and process to control the telephone device in its behavior concerning the exchange of speech or audio information. Examples of such processing include setup, maintaining and tearing down of packet streams for the exchange of the speech or audio signals.

Signaling is done between the telephone and a network device. If the phone is directly connected to another phone, the other phone is the network device. Other network elements like gateways, gatekeeper, or other devices may play the role of the network device as well. In VoIP technology, a gateway may translate between audio and signaling information on the VolP side of the gateway and the old telephony system standards.

VoIP defines signaling protocols for the exchange between the network element and the telephone, e.g. the H.323 protocol or the SIP protocol. The primary function of the gatekeeper in the H.323 model or the proxy in the SIP model (SIP—“SMDS Interface Protocol”) is to register attached telephones and determine their addresses on demand.

The different VoIP signaling protocols are much more complex than switched network technology for the exchange of electronic data and therefore require that the involved telephones are accordingly equipment with more resources, which on the one hand leads to increased costs compared to conventional telephones, like ISDN phones. This is particularly true for the H.323 protocol, because this protocol employs a coding technique that requires the implementation of a significantly large part of the whole protocol.

On the other hand, the signaling protocols undergo constant changes and further developments, which require a possibility to update the attached devices and causes increased maintenance cost.

To avoid these problems, the H.323 environment proposes to process at least some steps on a server device which is connected to the telephone. In this case, the network element which would like to exchange audio or speech information with the telephone device transmits the signaling information to the server device. The signaling information are processed in the server device, which generates stimulus signals. These signals are transmitted from the server device to the telephone using a stimulus protocol, so that the audio and speech information exchange of the telephone is controlled by the server device. Examples for the control signals may include the setup of a RTP connection (RTP—“Realtime Transport Protocol”). This known procedure handles the signaling on the server device. The devices that exchange speech and audio signals are not visible as network devices themselves and therefore not compatible to the signaling protocol. This means that each telephone using this technology needs to be connected to a gatekeeper, which causes additional costs during the installation. If the gatekeeper fails, all phones that are attached via the stimulus protocol are inoperative.

The object of the invention is to provide a procedure for control of telephony devices that allows to build cost effective telephones for the exchange of packet based speech or audio information with little technical effort that are compatible to the different signaling protocols.

This object is achieved by invention by a procedure according to claim 1 as well as by an apparatus according to claim 10.

One essential advantage of the invention in comparison to the state of the art is that is contains the possibility to use telephone devices in the scope of packet oriented telephony, that can be made simpler and therefore more cost effective with respect to their electronic components than devices that are currently used for packet based telephony. Using the invention, it is not necessary to include extensive memory that would be needed to electrically store information needed for processing signaling information (program and data space). The memory requirements of known VoIP telephones may be up to 16 MB. Using the invention, the memory requirements can be reduced to a large extent, e.g. 64 KB.

The proposed forwarding of the signaling information from the telephone to the server device as well as the processing in the server device allows that one server device offers its service to several telephone devices at the same time. Today supplying sufficient computing and memory resources is unproblematic, especially as they may be shared amongst different telephone devices. The telephone devices can be made simpler, because the processing of the signaling information is performed on the server device.

If the server device is registered in a network, especially the Internet, the processing resources for the processing of the signaling information may be distributed as functional elements in the network. This way a the load can be balanced between different server devices. In the case of a server failure this does not lead to a failure of all attached telephone devices, as the attached telephone devices may connect to the other server that are still up and running. The failure of the server and the fallback to another available server may be made invisible on the attached phones.

From the network element perspective that exchanges electronic data with the telephone device, namely speech and audio information, the telephone device behaves exactly like a normal telephone that processes the signaling on its own hardware. As a matter of fact, the signaling information are forwarded to the server device and processed there. To adapt to new standards or protocols for signaling, only the functional entities in the server devices need maintenance, without changing anything on the attached telephone devices. This way the maintenance and change effort is reduced, because it can be done completely or almost completely only once on the server device, and not several times on the telephone devices. All in all the interoperability of the attached telephone devices is improved, which is an important advantage when measurement and checking tools are attached.

From the network element perspective, the telephones can be addressed with the for the specific network valid signaling protocol and do not need, like in the above case of a gatekeeper providing stimulus protocol, a gatekeeper. Because of this, the case of failure of all telephones attached to a gatekeeper can not happen.

Another advantage of the invention is that the electronic data exchange between the telephone apparatus and a network element can be traced with standard measurement and checking equipment, especially for fault detection, because the exchange is being done using the signaling protocol that is used in that network.

A meaningful extension of the invention prescribes that the at least partially forwarded signaling information are transported using a tunneling protocol. This way it can be ensured that the transported signaling information can be processed easily and fast by the server device.

An advantageous elaboration of the invention may tag the at least partially forwarded signaling information with additional information about the sender on the telephone device which may be used in the server device for the mapping of the forwarded information to a telephone device. This way the at least partially forwarded information can be uniquely assigned to a specific telephone.

For the improvement of the time coordination or the processing and the transmission of the different electronic data another extension of the invention prescribes that the processing of the at least partially forwarded signaling information and/or the transmission of signaling information from the server device to the telephone over the server connection is done with a deterministic delay after the at least partially forwarded signaling information has been received from the telephone to the server device.

The usage of the method in different network environments is simplified in a meaningful extension of the invention in a way that the network element is a gateway from a VoIP based standard to another networking standard that may be a VoIP standard or another telephony standard.

A advantageous application for the method results from a preferred usage of the invention by the network element being another telephone device that is attached by another server connection to the same server device, so that the speech and audio information flows between these two telephone devices. In this case the server may be provisioned to detect that a message, which is generated in the server device of the telephone device, forwarded to the other telephone device and then forwarded to the server device, may bypass this path internally in the server device. This way several message transmissions can be avoided.

Meaningful is an extension of the invention that forwards the at least partial signaling information as electronic data packets. This way the transmission between the server device and the telephone device may use a packet oriented transmission medium.

To prepare a operation with least failure probability for signal transmission a meaningful extension of the invention may require that before the at least partial signaling information is forwarded from the telephone to the server device the telephone must register with the server device.

A preferred embodiment of the invention will electronically store information about the operating state of the telephony device, automatically contain information about the operating status of the telephone device during processing of the at least partially forwarded signaling information and automatically update the information about the operating status of the telephony device depending on the signaling information generated in the server device. This ensures that the at least partially forwarded signaling information without previous query of the operating state of the forwarding telephone can be process accordingly, which further supports the simplification of the telephone design.

A telephony apparatus according to claim 10 has the advantages of the procedure that has been shown in this document.

The invention will be described further, by way of example, with reference to the accompanying drawings

FIG. 1 shows a block diagram of a telephone device, a network element and a server device;

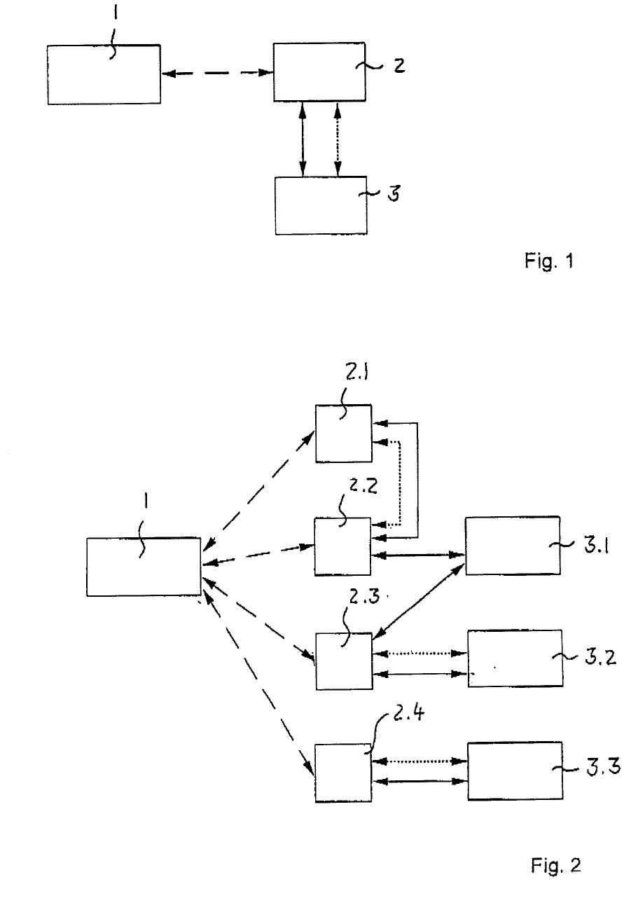

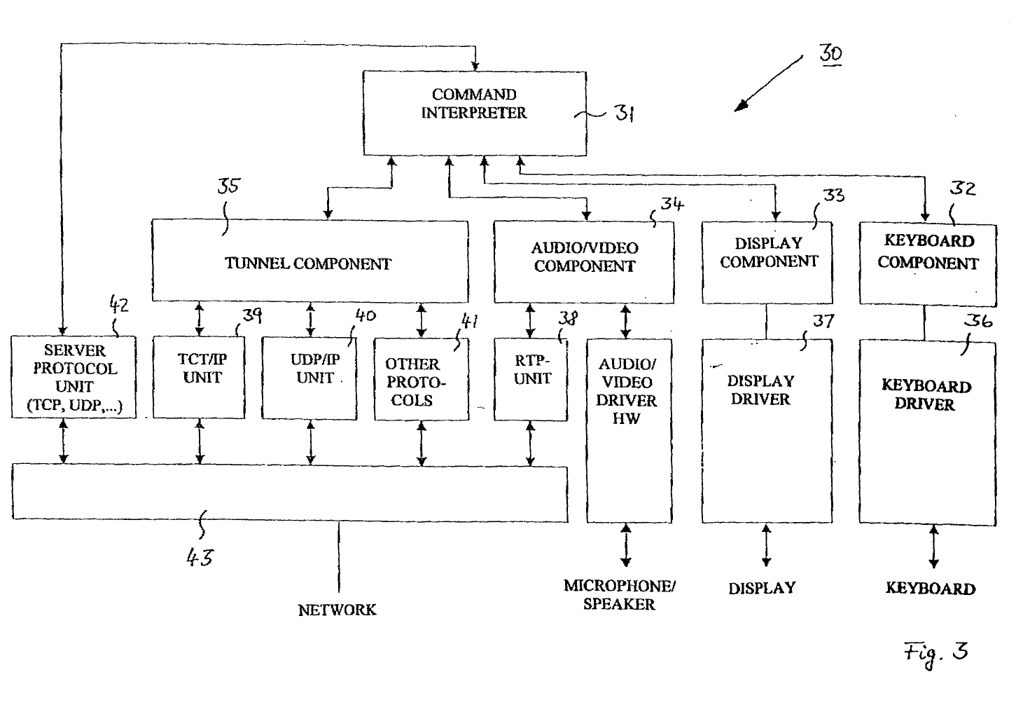

FIG. 2 shows a block diagram of a device which has several telephones connected to the server device;

FIG. 3 shows a schematic diagram of a telephone device.

According to FIG. 1 a server device 1 is connected to a telephone 2. Telephone 2 is connected with a network element 3. The shown architecture with server device 1, telephone 2 and the network element 3 is a basic structure for components executing the procedure shown in the subsequent paragraphs.

FIG. 2 illustrates that the server device 1 may be connected to several telephones 2.1, . . . , 2.4. The network element 3 may be another telephone 3.1, a gateway 3.2 or a gatekeeper 3.3, according to FIG. 2.

The arrows in FIGS. 1 and 2 between the respective components characterize the exchange of electronic data. The exchange of media data, especially audio data, is shown in dotted lines. Straight lines represent the exchange of signaling information. Electronic data exchange through the tunnel protocol is shown with dashed lines.

The following refers to FIG. 1. During a packet oriented telephony conversation on the basis of the new procedure firstly signaling information from network element 3 is being transferred to telephone 2. The following methods may serve as examples:

A packet of signaling information is sent via the UDP/IP (UDP “User Datagram Protocol”) to a specific port of telephone 2.

A packet of signaling information is sent via the TCP/IP (TCP—“Transmission Control Protocol”: IP—“Internet Protocol”) to a specific port of telephone 2 (RFC1006).

A TCP/IP packet of signaling information is being sent to telephone 2. The underlying packet for the TCP/IP packet (e.g. an Ethernet-Packet) is forwarded to server 1. In this case the server device also handles the TCP/IP layer of the protocol.

In this case the port is a number, preferably a 16 bit number for identification. Usually different port numbers allow detection of different transport layer protocols and connections for the data traffic.

Telephone 2 receives the packet containing the signaling information and sends it as a packet, which contains the signaling information and complies to a tunnel protocol specification, to server device 1.

The tunnel protocol packet preferably contains the following protocol elements;

Sender: Identity of the sender of the tunneled packet;

Timestamp (optional): Time when the tunneled data packet has been received;

Length: Length of the tunneled packet in bytes;

Data: Data of the tunneled packet.

Other protocol elements may be additional or alternative information, e.g. address of telephone 2 in the network or information about the operational state of telephone 2 as the state of keys or switches.

The server device 1 receives the tunnel data packet and assigns the packet to telephone 2 because of the sender information. The server device 1 processes the tunnel data packet in the context of the sender (telephone 2) and responds in a way that one or more response tunnel packet are sent back to telephone 2. Processing in the context of telephone 2 means that state information about telephone 2 are respected automatically. State information about telephone 2 may contain information that have been stored in a memory that is accessible to server device 1. This state information may be change during the processing of the tunnel packet, meaning that information about changed state of telephone 2 caused by a or all response tunnel packet are being stored. Additionally, the in server device 1 automatically processed information may contain information about the operating state of telephone 2, that are included in the received tunnel packet.

Tunneling answer packets may contain the following information:

Recipient: Address of the recipient of the answer tunneling data packet (e.g. address of telephone 2);

Length: Length of the tunneling answer packet;

Data: tunneling answer data packet data.

The number of tunneling answer packets may vary between zero, one or at least two according to the processing of the tunneling packet. The response to a tunneling packet by one or more tunneling answer packet(s) may be immediately (if the response should be as soon as possible) or after a predefined timeout (e.g. after a timeout). Telephone 2 does not wait for a message from server device 1; it is all the time, that means also during the processing on server device 1, able to receive and forward further signaling information from and to the server device.

Initially, between the server device 1 and the telephone 2 a connection is set up. This connection may be a TCP/IP connection, but may also be achieved e.g. by using the UDP protocol as transport layer.

The following describes in an example, how a connection between telephone 2 and the server device 1 is set up, a tunnel packet to the server device 1 is being sent and a tunneling answer packet is sent back from the server device 1 to the telephone 2. The exchanged electronic messages start with a “C”, if the message is a command (message from server device 1 to telephone 2), and start with a “E” if the message is a event (message from telephone 2 to server device 1). After the C or E follows a number that describes the sequence of the messages. The word “TUNNEL” indicates that the messages concern the tunneling of packets.

(a) Setting Up of a Connection

To set up a port commands are used that may set up TCP/IP or UDP/IP connections. These commands may look for the TCP case like this:

(1.) C1 1 TUNNEL TCP SETUP CON1 1720 192.186.0.24

(2.) C1 TUNNEL TCP SETUP CON1 1720

(3.) C1 TUNNEL TCP CLOSE CON1

(4.) E1 TUNNEL TCP ACCEPT CON1 192.186.0.24

(5.) E1 TUNNEL TCP CLOSE CON1

The first message (1.) is used to set up a TCP client. The arguments indicate, to which port the connection should be set up. The second message (2.) is used to set up a TCP server. In this case on the local port is indicated, because the telephone 2 does not know in the beginning which client will connect. A connection may be closed using the Close command.

If the telephone 2 receives a connection, it sands a message “TUNNEL TCP ACCEPT”. This way the signaling unit is able to read subsequent messages and become active. If a connection is closed or broken, a Close message is sent.

UDP ports are connection less in principle. Because of this, a slightly different message structure is appropriate. Only a port with a predefined port number is set up. A UDP port is closed like a TCP port, the internal resources are released. The messages for this may look like this:

C1 TUNNEL UDP SETUP CON2 1720

C1 TUNNEL UDP CLOSE CON2

(b) Sending of Messages

Sending of messages over a TCP or UDP port may look like this:

E1 TUNNEL TCP POU CON1 2000122119324300 12 43AC3245F43DA32BA4309345 (example 1)

E1 TUNNEL UDP POU CON2 192.186.0.28 1234 14 2000122119324300 12 43AC3245F43DA32BA4309345 (example 2)

The words TCP and UDP indicate, that the message is a TCP (example 1) or UDP (example 2) message, respectively. The word PDU indicates, that the message reports an incoming packet. The message relates to the connection named “CON1” that has been set up before (see (a)). The date in this example if Dec. 21, 2000 19:32 and 430 ms. The contained message has the length 12 bytes and contains the values (hexadecimal) 0x43, 0xAC, 0x32, 0x45, 0xF4, 0x3D, 0xA3, 0x2B, 0xA4, 0x30, 0x93, 0x45.

In the second example (example 2) a UDP messages is indicated. In this type of message the origin of the message must be indicated as well, because this may change from message to message.

The server device 1 processes the message as if telephone 2 would have done in the scope of the underlying signaling protocol (e.g. H.323). This is achieved by automatically using the stored information about the state of telephone 2. Server device 1 changes this state information after processing of the message. Depending on the underlying transport protocol (TCP (example 1), UDP (example 2), . . . ) the response may look like this:

C1 TUNNEL TOP PDU CON1 14 4A43AC3245F4305A32BA46309345 (example 1)

C1 TUNNEL UDP PDU CON2 192.186.0.28 1234 14 4A43AC3245F43D5A32BA46309345 (example 2)

In example 1 the message is sent over TCP/IP back to the original sender 192.168.0.123 at port 1720. The message is 14 bytes long and has the indicated content. In example 2 the message is sent via UDP; because this protocol does maintain a connection, the destination address is provided.

FIG. 3 shows a schematic diagram of a VoIP telephone 30 that can be used in the previously described procedure. A command interpreter 31 processes the messages received from the server device 1 (see FIG. 1) and forwards these to other internal components of the VoIP phone 30. The different components consist in the shown example a keyboard component 32, a display component 33, a audio/video component 34 and a tunnel component 35. The keyboard component 32 processes the input from the user that are being read via the keyboard driver 36 and forwards these inputs to the command interpreter 31. The display component 33 renders the display contents that have been determined in the server device 1 via the display driver 37 to the user. The audio/video component 34 plays the received RTP audio information on the speaker and transmits the recorded audio samples to the RTP unit 38.

The tunnel component 35 processes commands from command interpreter 31, as described in the tunnel protocol, and is connected to the three units 39, 40, 41, which are controlled by the tunnel component 35. The TCP/IP unit 39 processes the TCP/IP ports, the UDP/IP unit 40 the UDP/IP ports. Unit 41 is used to process other protocols, like plain Ethernet packets, and can be used alternatively to the UDP/IP and TCP/IP ports.

Upon reception of messages to one of the units tunnel component 35 forwards the message according to the tunnel protocol to the command interpreter 31. Command interpreter 31 itself is connected via a server protocol unit 42 to the network. Server protocol unit 41 ensures that the telephone 30 can communicate directly with the server device 1.

Server protocol unit 42, the TCP/IP- and UDP/IP-unit 39 and 40, the unit for the other protocols 41 as well as the RTP unit 38 are connected to a network driver 43, which directly communicates with the underlying hardware. Typically, this is a Ethernet driver.

The features that have previously been described in figures and text and the features that are revealed in the claims may be relevant alone and in any combination for the implementation of the invention in its different forms of appearance.

What is claimed is:

1. A method for control of a telephony device (2), that has at least one connection for exchanging packet oriented audio data and at least one additional connection for the exchange of signaling data with a network element (3) as well as one server connection, where the telephony device may be connected to the server device (1) in a way that between the telephone device (2) and the server device (1) electronic data are exchangeable, the method comprising the following steps:
transmission of signaling data from a network element (3) to the telephone device (2) over at least one additional connection;
at least partial forwarding of the received signaling information from the telephone device (2) to the server device (1) over the server connection;
processing of the at least partial forwarded signaling information using the server device (1), so that the signaling information for the telephone device (1) are generated;
transmission of the signaling information from the server device (1) to the telephone device (2) via the server connection; and
processing of the transmitted signaling information in the telephone device (2) in a way that the control of the telephone device concerning a packet oriented exchange of audio data via at least one connection according to the exchanged signaling information is accomplished.

2. The method as claimed in claim 1, wherein that the at least partially forwarded signaling data are forwarded using a tunnel protocol.

3. The method as claimed in claim 1, wherein that the at least partially forwarded signaling data are tagged with electronic source indication before they are forwarded to the server device (1), which is used by the server device (1) to assign the at least partially forwarded signaling data the telephone device (2).

4. The method as claimed in claim 1, wherein that the processing of the at least partially forwarded signaling data by the server device (1) and/or the transmission of signaling information from the server device (1) to the telephone device (2) via the server connection takes place with a predefined delay after the at least partially forwarding of the received signaling information from the telephone device (2) to the server device (1).

5. The method as claimed in claim 1, wherein that the network element is a gateway (3.2) for automatic conversion of the audio data and/or signaling information from one electronic network standard to another network standard and vice versa.

6. The method as claimed in claim 1, wherein that the other network element is another telephone device (2.1), which is connected with the server device (1), so that the audio data and the signaling information between the telephone device (2.2) and the other telephone device (2.1) can be exchanged.

7. The method as claimed in claim 1, wherein that the at least partially forwarded signaling data are forwarded as electronic data packets.

8. The method as claimed in claim 1, wherein that before signaling data is at least partially forwarded from the telephone device (2) to the server device (1) via the server connection, a electronic registration of the telephone device (2) at the server device (1) is performed.

9. The method as claimed in claim 1, wherein that the server device (1) electronically stores information about the operating state of the telephone device (2), the information about the operating state of the telephone device (2) during the processing of the at least partially forwarded signaling data in the server device (1) automatically are taken into account and that the information about the operating state of the telephone device (2) depending on the in the server device (1) generates signaling information for the telephone device (2) are updated automatically.

10. A telephony apparatus (2) comprising:
at least one connection for packet oriented exchange of audio data with a network element (3), which can be connected with at least one connection;
at least one additional connection for the exchange of signaling information with the network element (3), which can be connected with at least one additional connection;
means for the at least partial forwarding of signaling information to a server device (1) after receiving of signaling data via at least one additional connection; and
a processing unit for the electronic processing of signaling information after reception via a server connection from a server device (1), where the signaling data are a electronic response to a at least partial forwarded signaling information and are can be processed by a unit for the control of packet oriented exchange of audio data with a network element (3).
